(19) United States
(12) Patent Application Publication
(10) Pub. No.: US 2010/0263044 A1
(43) Pub. Date: Oct. 14, 2010

(54) INFORMATION PROCESSING APPARATUS, CONTROL METHOD OF INFORMATION PROCESSING APPARATUS, AND STORAGE MEDIUM

(75) Inventor: Naoto Yamada, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/756,104

(22) Filed: Apr. 7, 2010

(30) Foreign Application Priority Data
Apr. 9, 2009 (JP) 2009-094598

(51) Int. Cl. G06F 21/04

(52) U.S. Cl. 726/17

(57) ABSTRACT

In a case where image data stored in an information processing apparatus is output to an image processing apparatus, lowering of security level due to a difference of the authentication level between authentication units of the respective apparatus can be restricted. A control method for controlling an information processing apparatus for outputting image data to an image processing apparatus that permits a use of the image data provided that a user authentication unit authenticates a user includes selecting an image processing apparatus that serves as an output destination of the image data among a plurality of image processing apparatuses, determining whether an authentication level of a user authentication unit necessary for permitting a use of the selected image processing apparatus is lower than an authentication level of the authentication unit necessary for permitting a use of the information processing apparatus, and restricting an output of the image data to the selected image processing apparatus in a case where it is determined that the authentication level is lower.

### BACKGROUND OF THE INVENTION

1. Field of the Invention

The present invention relates to an information processing apparatus, a control method of the information processing apparatus, and a storage medium thereof.

2. Description of the Related Art

Conventionally, there has been an information processing apparatus (personal computer (PC) and the like) and an image processing apparatus (multifunction peripheral (MFP) and the like) in which a user is assigned with a right to use the information processing apparatus or the image processing apparatus when the information processing apparatus or the image processing apparatus authenticates the user according to a password. Information of image data stored in the information processing apparatus or the image processing apparatus can be restricted from being output by unspecified users and thereby being leaked by requesting authentication of the user in order to use the apparatus.

Japanese Patent Laid-open No. 2006-153981 discusses a user authentication method in which biological information such as fingerprint information and/or voiceprint information of the user is used in addition to a method in which a password is used.

However, in a case where the image data stored in the information processing apparatus is output to the image processing apparatus, a security level may be lowered due to a difference of the authentication level between authentication units of the individual apparatus.

For example, a case is assumed where the image data stored in the information processing apparatus, in which a use of the image data is permitted on condition that the authentication is performed based on the finger print information in addition to the password, is output to another image processing apparatus other than the information processing apparatus. If the another image processing apparatus does not require an input of the fingerprint information but permits a use of the image data when only the password is input, the security level is lowered since the authentication according to the fingerprint information is not performed.

### SUMMARY OF THE INVENTION

According to an aspect of the present invention, an information processing apparatus for outputting image data to an image processing apparatus, which permits a use of the image data provided that a user authentication unit authenticates the user, the information processing apparatus includes a selecting unit configured to select an image processing apparatus as an output destination of the image data, among a plurality of image processing apparatuses, a determining unit configured to determine whether an authentication level of the user authentication unit necessary for permitting a use of the image processing apparatus selected by the selecting unit is lower than an authentication level of an authentication unit necessary for permitting a use of the information processing apparatus, and a control unit configured to restrict outputting of the image data to the image processing apparatus selected by the selection unit in a case where the determining unit determines that the authentication level is lower.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image processing system.

FIG. 2 is a block diagram illustrating a configuration of an image processing apparatus.

FIG. 3 is a block diagram illustrating a configuration of an identification (ID) authentication input apparatus.

FIG. 4 illustrates a fingerprint reading unit in detail.

FIG. 5 is a table illustrating an example of a security level management table.

FIG. 6 is a flow chart illustrating data processing steps of an information processing apparatus.

FIG. 7 illustrates an example of a user interface (UI) displayed on a display device.

FIG. 8 illustrates another example of the UI displayed on the display device.

FIG. 9 is a flow chart illustrating data processing steps of the image processing apparatus.

FIG. 10 illustrates an example of the UI displayed on an operation unit 2d.

FIG. 11 illustrates another example of the UI displayed on the operation unit 2d.

### DESCRIPTION OF THE EMBODIMENTS

Various exemplary embodiments, features, and aspects of the invention will be described in detail below with reference to the drawings.

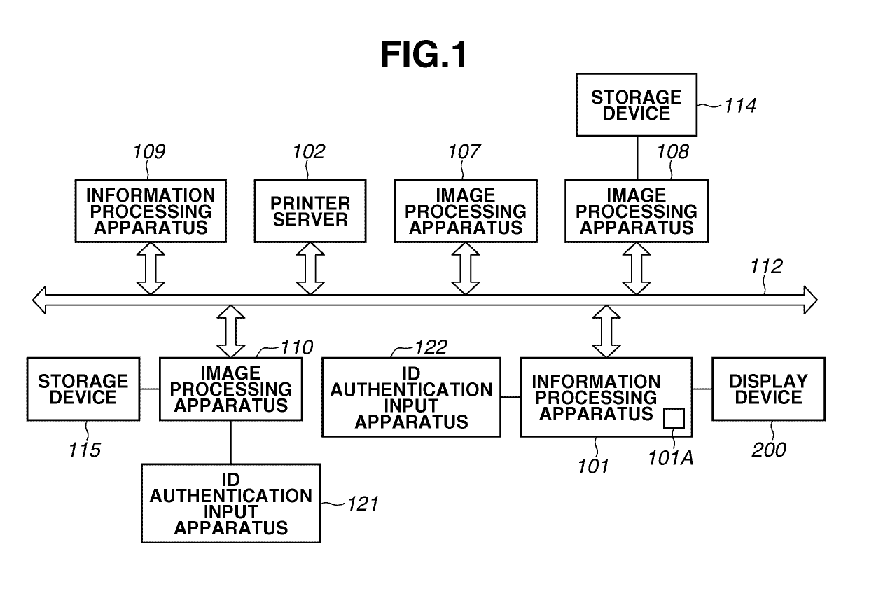

FIG. 1 is a block diagram illustrating a configuration of an image processing system as an example of the information processing system according to the present exemplary embodiment.

In FIG. 1, information processing apparatus 101 and 109 are, for example, personal computers (PCs). The PC 101 and the PC 109 can transmit image data (text data) to the image processing apparatus, a server, and the information processing apparatus on a network. The image data is generated, for example, by executing application software of the PC 101 or the PC 109.

The information processing apparatus 101 and 109, respectively, include a keyboard and can receive a user identification (ID) and a password from a user through the corresponding keyboard. Further, the information processing apparatus 101 and 109, respectively, include an ID registration unit in which the user ID and the password of the respective users are preliminary registered. Still further, the information processing apparatus 101 includes an ID authentication input apparatus 121 for inputting biological information of the user such as fingerprint information. The information processing apparatus 101 includes a central processing unit (CPU) 101A.

When the user inputs the password, the information processing apparatus 101 performs an authentication of the user by the input password. In a case where the authentication is successful, the information processing apparatus 101 assigns a right to use the information processing apparatus 101. The authentication of the user is performed in such a manner that the input password is checked with the preliminary registered password, or such that the input biological information is checked with the preliminary registered biological information.

When the user is assigned with the right to use the information processing apparatus 101, the user can use (print, transmit or output) image data in the information processing apparatus 101. In a case where the user inputs the password and the fingerprint information, the information processing apparatus 109 performs authentication of the user by the password and the fingerprint information. When the authentication is successful, the user is assigned with the right to use the information processing apparatus 109.

When the user is assigned with the right to use the information processing apparatus 109, the user can use (print, transmit, or output) the image data in the information processing apparatus 109. A printer server 102 performs management of a print queue, management of a user count or the like. The image processing system includes a display device 200.

The printer server 102 is connected to a network 112 (including an internet, a local area network (LAN) or the like) and holds therein various image data and text data.

Image processing apparatus 107, 108, and 110, respectively, include a large touch panel, and configured with a multi function peripheral (MFP) having a scanner function and a printer function. In other words, the image processing apparatus 107, 108, and 110, have a copying function by itself and further has a function of an electronic box apparatus when the image processing apparatuses are connected respectively to storage devices 114 and 115. Each of the storage devices 114 and 115 includes various storage units such as a hard disk and a magnet-optical disk unit.

Further, the image processing apparatus 107, 108, and 110, respectively, function as a printer for information processing apparatus 101 and 109. Therefore, the image processing apparatus 107, 108, and 110 receives a command data for forming an image of a document, which is created by the information processing apparatus 101 and 109, through a network 112, and rasterizes the image of the document to bit map image data in order to print the image data.

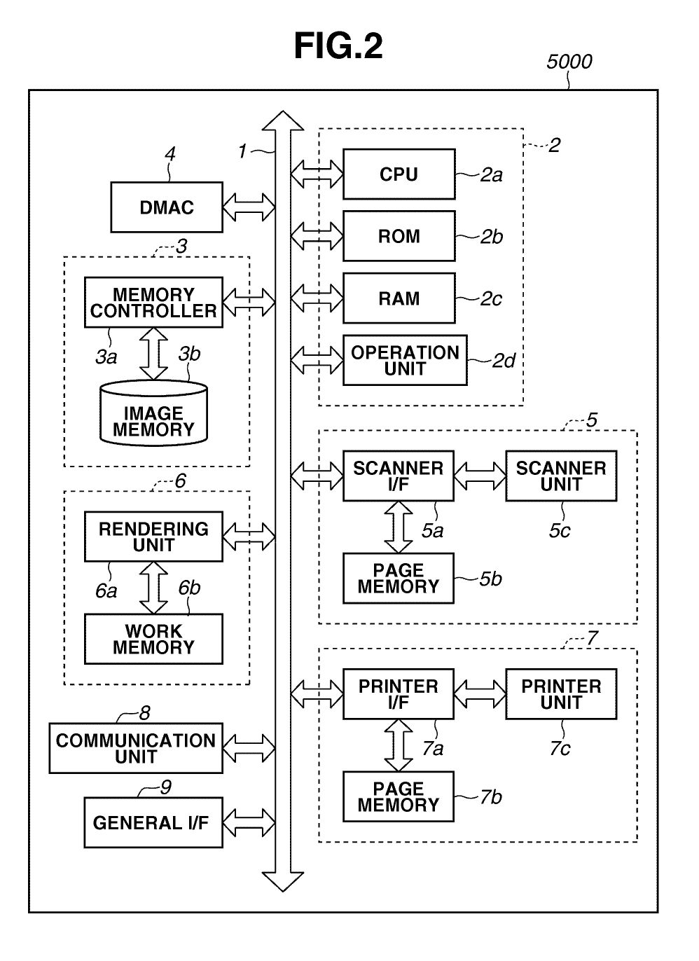

The image processing apparatus 110 receives input of biological information such as the fingerprint information of the user that is input from an ID authentication input apparatus 122. The ID authentication input apparatus 122 has the same configuration as an ID authentication input apparatus 121. Further, the image processing apparatus 110 includes an operation unit 2d illustrated in FIG. 2, which is described below, and accepts an input of a password through the operation unit 2d.

In the present exemplary embodiment, the image processing apparatus 107 does not include the above-described ID authentication input apparatus 121. The image processing apparatus 107 does not include an input system for inputting the password according to a key inputting operation through the operation unit 2d in FIG. 2.

The image processing apparatus 107 permits the user to use the image processing apparatus 107 without performing the authentication of the user by using the password and/or the biological information. Accordingly, the image processing apparatus 107 functions as the image processing apparatus of the lowest security level (i.e., authentication level) in the image processing system in FIG. 1.

The image processing apparatus 108 receives an input of the password according to the key inputting operation through the operation unit 2d (FIG. 2). The image processing apparatus 108 authenticates the user according to the password input by the user and assigns a right to use the image processing apparatus 108 to the user provided that the authentication is successful. However, the image processing apparatus 108 does not include the ID authentication input apparatus 121 that the image processing apparatus 110 includes.

The image processing apparatus 107, 108, and 110 in the present image processing system function as the image processing apparatus having different security levels (i.e., authentication levels). When the user of the information processing apparatus 101 and 109 selects the image processing apparatus for outputting image data generated by executing an application, the following control is executed.

FIG. 2 is a block diagram illustrating a configuration of the image processing apparatus 110 illustrated in FIG. 1.

In FIG. 2, a CPU bus 1 is connected to a system control unit 2, an image memory 3, a direct memory access controller (hereinafter merely referred to as the “DMAC”) 4, an image reading unit 5, an image rasterizing unit 6, and an image forming unit 7.

The system control unit 2 includes a central processing unit (CPU) 2a, a read only memory (ROM) 2b, a random access memory (RAM) 2c, and an operation unit 2d. The CPU 2a controls the above-described image processing apparatus 110 in its entirety. A control program to be executed by the CPU 2a is stored in the ROM 2b. The RAM 2c is a memory temporality used when the CPU 2a performs a calculation. The RAM 2c is used for executing the control program.

For example, when a control command, such as an activation instruction, is output to the image reading unit 5, the image rasterizing unit 6, and the image forming unit 7, the control command is written into the RAM 2c by the CPU 2a. Then, when an end notification indicating that writing of image data is completed is given, the CPU 2a checks if this end notification is made in response to the control command.

The operation unit 2d is used for a user interface between the user and the present apparatus. The CPU 2a executes a predetermined data processing according to an instruction from the user through the user interface.

An image memory unit 3 includes a memory controller 3a and an image memory 3b. The image memory 3b is a memory having a relatively larger capacity, e.g., a capacity for a plurality of pages. Code data (not illustrated) is stored in the image memory 3b by a coding process. The DMAC 4 executes a data transfer between each of the devices without using the CPU 2a. The DMAC 4 can perform a high-speed data transfer in comparison with that by the CPU 2a.

The image reading unit 5 processes document data read by the above-described scanner unit 5c, and includes a scanner interface 5a, a scanner unit 5c and a page memory 5b.

The scanner interface 5a drive-controls the scanner unit 5c and controls writing, and reading of image data (DATA) in the page memory 5b. The page memory 5b is a memory for storing image data corresponding to one page from the scanner unit 5c. The page memory 5b is necessary for improving an adjustment of the data transfer speed between the scanner unit 5c and the CPU 2a, and a use efficiency of the CPU bus 1.

The image rasterizing unit 6 includes a communication unit 8, which takes a roll of an interface with a network connected to the CPU bus 1. Then, the image rasterizing unit 6 receives through the communication unit 8 a print job created by application software of each of the client's terminals on the network. A rendering unit 6a rasterizes the received print job to data that can be handled by each of the processing units connected to the rendering unit 6a through the CPU bus 1 by using a work memory 6b also connected to the rendering unit 6a.

The image forming unit 7 includes a printer interface 7a, a page memory 7b, and a printer unit 7c. The printer interface 7a drive-controls the printer unit 7c, and controls writing and reading of the image data in the page memory 7b.

The page memory 7b is a memory in which data to be written into the printer unit 7c is stored for one page. The page memory 7b is necessary for improving the adjustment of the data transfer speed between the printer unit 7c and the CPU 2a, and a use efficiency of the CPU bus 1. Data of each page stored in the page memory 7b is transmitted to a laser drive unit (not illustrated) in the printer unit 7c per each page to be converted into an image. Thus, converted image is subjected to image forming processing.

Since the above-described configuration is identical to those of the image processing apparatus 107 and 108, descriptions thereof are omitted here. In the present exemplary embodiment, the image processing apparatus 110 is configured so that the above-described ID authentication input apparatus 121 is connectable to a general-purpose interface 9. In the image processing apparatus 110, ID authentication information, which is encoded and input from the ID authentication input apparatus 121, is analyzed by the CPU 2a and subjected to authentication processing through the CPU bus 1.

The ID authentication input apparatus 121 can be formed into, for example, a fingerprint reading apparatus or a fingerprint information sensor. In the present exemplary embodiment, in order to provide a high security authentication system, description is made using an example in which the fingerprint reading apparatus, which performs authentication according to the fingerprint information, is used as the ID authentication input apparatus 121.

In the present exemplary embodiment, a fingerprint is detected, but not limited thereto, as data to be used in checking with the authentication information. Therefore, checking of the authentication information can be performed by using other biological information such as face information based on a pattern of a face of a human being, voice information, vein information, palm print information, or iris information.

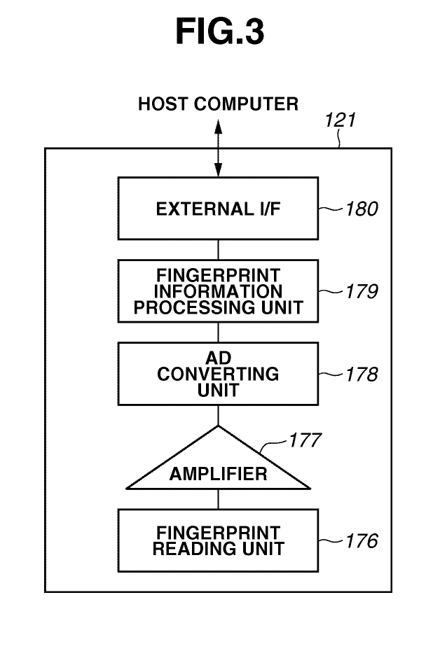

FIG. 3 is a block diagram illustrating a configuration of the ID authentication input apparatus 121 of FIG. 1. In FIG. 3, the fingerprint reading unit 176 captures an image of the fingerprint of the user, and an analogue image signal corresponding to the fingerprint of the user is amplified by an amplifier 177. An analog digital (A/D) converting unit 178 converts the analogue image signal of the fingerprint having been amplified by the amplifier 177 into digital data, and outputs the converted data to a fingerprint information processing unit 179.

The fingerprint information processing unit 179 extracts feature quantity data of the fingerprint information, which is converted into digital data, and outputs the extracted fingerprint feature quantity data onto the CPU bus 1 through an external interface (I/F) 180 and a general-purpose I/F 9 of a host computer side.

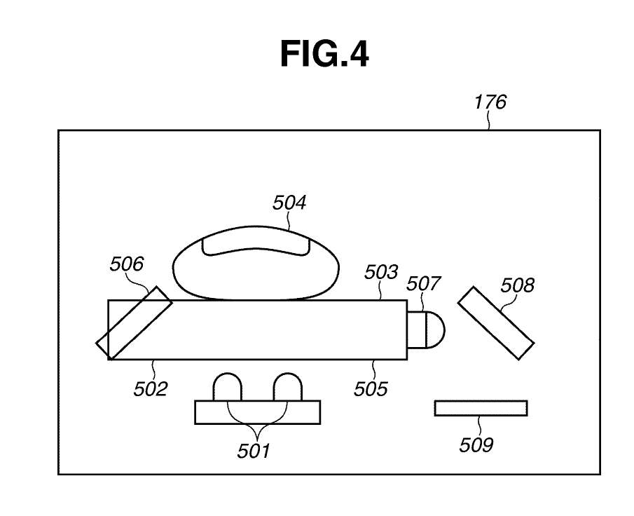

FIG. 4 illustrates the fingerprint reading unit 176 illustrated in FIG. 3 in detail.

In FIG. 4, light emitting diodes (LEDs) 501 irradiate a predetermined intensity of light onto a reading surface 503, which is an upper surface of a flat glass 502. On the reading surface 503, a finger 504 of the user is placed.

Reflection light of convex portions of the fingerprint among the reflection light reflected against the reading surface 503 is totally reflected against a reflecting surface 505 of the flat glass 502, whereas reflection light of concave portions of the fingerprint transmits through the flat glass 502. The reflection light of the convex portions of the fingerprint having been totally reflected against the reflecting surface 505 is reflected by a reflection mirror 506 and concentrated by a lens 507.

The reflection light concentrated by the lens 507 is further reflected by a reflection mirror 508 to be incident into a reading sensor 509. The reading sensor 509 converts a light (image) signal into an electric signal by using a semiconductor device (photodiode) of which charge capacity varies according to an input amount of light.

Now, the printer server 102, which manages the image processing apparatus 107, 108, and 110 connected to the network 112, is described below. In the present exemplary embodiment, security levels of the image processing apparatuses are managed independently.

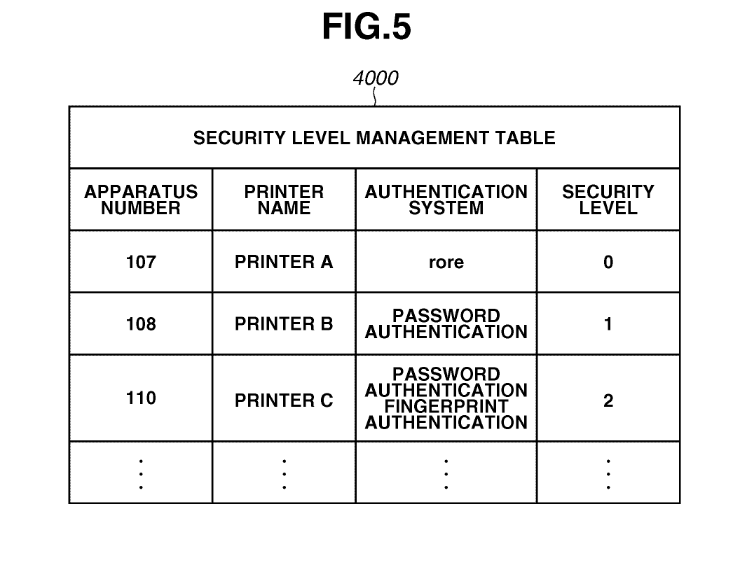

FIG. 5 illustrates an example of a security level management table that is managed by the printer server 102 in FIG. 1. The printer server 102 includes a hardware resource identical to a hardware resource of the personal computer device and a software resource for executing a server function. The hardware resource here includes a controller including a CPU, a ROM, and a RAM, an input device such as a keyboard or a pointing device, a display device, and an external storage device.

As illustrated in FIG. 5, in a security level management table 4000, the image processing apparatus 107, 108, and 110 in FIG. 1, respectively, are managed so as to be related to the corresponding authentication device and the corresponding security level of the system installed in the respective image processing apparatuses.

The security level management table 4000 managed by a memory in the printer server 102 manages an apparatus number, a printer name, an authentication system, a security level for each of the image processing apparatus connected to the network 112. The printer of the image processing apparatus 107, 108, and 110 are named as a printer A, a printer B, and a printer C, respectively.

In the present exemplary embodiment, as illustrated in the security level management table 4000, the authentication device and the authentication system installed in the respective image processing apparatus 107, 108, and 110 are managed for each of the image processing apparatuses. In the security level management table 4000, as a value of the security level becomes larger, the authentication device and the authentication system become of higher levels. Herein, “3” is the highest security level. Now, the security level is described below.

For example, in a case where the authentication of the password is performed based on the password input by the user as personal information using the key inputting operation through the operation unit 2d, the security level “1” is assigned to the apparatus. In a case where the authentication is performed based on the biological information such as the fingerprint information by using the ID authentication input apparatus 121, which is connected to the image processing apparatus 110 in addition to the authentication based on the password, the security level of “2” is assigned to the apparatus.

In the present exemplary embodiment, the larger value is assigned to the image processing apparatus of the higher security level, thereby enabling a simple and unified management of the security level.

A security level “0” is assigned to the image processing apparatus 107 that does not correspond to either one of the security levels “2” or “1”, i.e., which has no authentication function. The security level is rewritable according to a change of the authentication method of each of the image processing apparatus.

In the present image processing system, the authentication system of each of the image processing apparatus is notified to the printer server 102 from each of the image processing apparatus 107, 108, and 110 upon starting up the system. The authentication system here means a type of the authentication processing required to be performed in order for the user to obtain the right to use the image processing apparatus in the image processing apparatus. The printer server 102 manages the security level of each of the image processing apparatus by the security level management table 4000 based on the notified authentication system.

For example, in a case where the printer server 102 determines that the authentication system notified from the image processing apparatus requires only the authentication of the password, the security level of the image processing apparatus is set to 1. In a case where the printer server 102 determines that the authentication system notified from the image processing apparatus requires the authentication of the biological information in addition to the password, the security level of the image processing apparatus is set to 2.

Hereinafter, a case where the user selects one of the image processing apparatuses that are connected to the network, and performs secure print processing on the print data generated by the information processing apparatus according to the present exemplary embodiment, is described below.

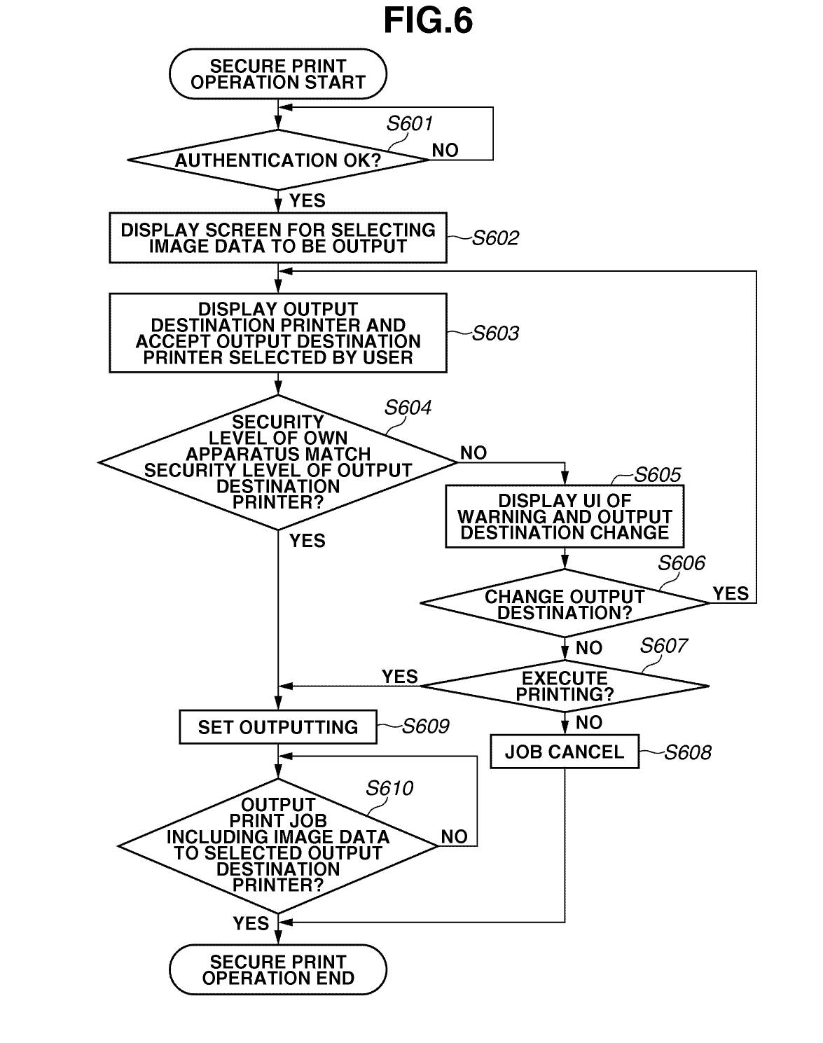

FIG. 6 is a flowchart illustrating an example of data processing steps of the information processing apparatus according to the present exemplary embodiment. Each of the steps is realized by the CPU 101A of the information processing apparatus 101 by loading and executing the printer driver onto/on the RAM.

In the present exemplary embodiment, an example that the information processing apparatus 101 outputs image data in order to cause the image processing apparatus to print the image data is described. However, it is not limited thereto. In addition to the above, the information processing apparatus 101 may outputs the image data in order to cause the image data to be stored in the image processing apparatus or in order to cause the image data to be transmitted to the image processing apparatus.

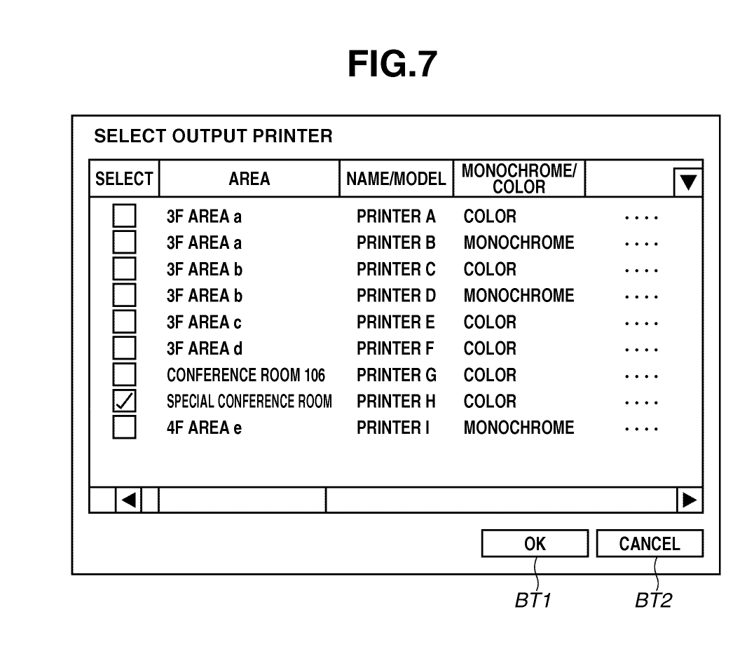

FIG. 7 illustrates an example of the user interface displayed on a display device 200 of the information processing apparatus 101 of FIG. 1. In FIG. 7, the user interface provided by the printer driver is exemplified. The display form of the user interface is not limited to that of the present exemplary embodiment. The user interface may be formed into a display form in which the image processing apparatus for printing print data is selectable according to an instruction method other than a method using a check box.

In the example illustrated in FIG. 7, a case where an area, a name/model/monochrome/color, IP address, and the like are clearly indicated as attribute information of the image processing apparatus, is described. However, they may be displayed in such a manner that the pieces of attribute information are displayed in the form of icons on the network so as to make it easier to find the attribute information. A button BT1 is clicked when the image processing apparatus selected by the check box is determined, whereas a button BT2 is clicked when the present user interface is closed.

Now, a case is described below where the image data (print data) generated in the information processing apparatus 101 is transmitted to an image memory 3b of the desired image processing apparatus and thereafter the user instructs printing of the image data by the image processing apparatus. The information processing apparatus 101 includes, as illustrated in FIG. 1, an ID authentication input apparatus 121, and requires the authentication of the password and the authentication of the fingerprint information in order for the user to obtain a right to use the information processing apparatus 101.

When a user uses the information processing apparatus 101, the user inputs the user ID and the password that are preliminary registered in the information processing apparatus 101. The user inputs the fingerprint information by using the ID authentication input apparatus 121, which is connected to the information processing apparatus 101.

In step S601, the CPU 101A of the information processing apparatus 101 determines whether or not each of the input ID number, pass word, and fingerprint information matches the registered authentication information, thereby determining whether or not the user authentication is successful. The authentication information, which is compared with the input authentication information, may be registered in the information processing apparatus 101, or alternatively may be acquired from the printer server 102. In a case where the authentication information is acquired from the printer server 102, the security of the authentication information can be kept by encoding the authentication information to be acquired.

In step S601, the CPU 101A of the information processing apparatus 101 compares the input ID number with the acquisition number, the fingerprint information of the user with the authentication information to determine whether or not they match each other. When the CPU 101A of the information processing apparatus 101 determines that the authentication is not successful (NO in step S601), the step S601 is repeated.

On the other hand, in step S601, when the CPU 101A of the information processing apparatus 101 determines that the authentication was successful (YES in step S601), the right to use the information processing apparatus 101 is assigned to the user, and then the processing proceeds to step S602. Since the user is assigned with the right to use the information processing apparatus 101, the user comes to be able to display, print and transmit the image data stored in the information processing apparatus 101.

In step S602, the CPU 101A of the information processing apparatus 101 displays a screen (not illustrated) for selecting image data to be output on the display device 200. In step S603, the CPU 101A of the information processing apparatus 101 displays a selection screen for selecting the image processing apparatus as the output destination printer in FIG. 7 on the display device 200.

Further, the CPU 101A of the information processing apparatus 101 accepts the output destination printer after the user checks the output destination printer in the printer driver screen in FIG. 7. In FIG. 7, a description is continued hereinafter provided that the user selected the image processing apparatus 107 as the desired output destination printer to which the user desires to output data. The image processing apparatus 107 has, as illustrated in FIG. 5, no authentication system.

The CPU 101A of the information processing apparatus 101 inquires the security level of the image processing apparatus 107 to the printer server 102. The printer server 102 responds to the information processing apparatus 101 the security level corresponding to the image processing apparatus 107 with reference to the security level management table 4000, which is managed by the printer server 102.

Then, the CPU 101A of the information processing apparatus 101 determines whether or not the security level responded from the printer server 102 matches the security level of the information processing apparatus 101. The security level of the information processing apparatus 101 may be obtained from the printer server 102 or alternatively, may be preliminary registered in the information processing apparatus 101.

The CPU 101A of the information processing apparatus 101 determines that, since the security level of the image processing apparatus 107 is “0” because the image processing apparatus 107 does not include a system for authentication, the security level of the information processing apparatus 107 does not match the security level “2” set to the selected image data (NO in step S604). In other words, the CPU 101A determines that the security level of the authentication system necessary for permitting the user to use the image data in the image processing apparatus 107 is lower than that of the authentication system necessary for permitting the user to use the image data in the information processing apparatus 101.

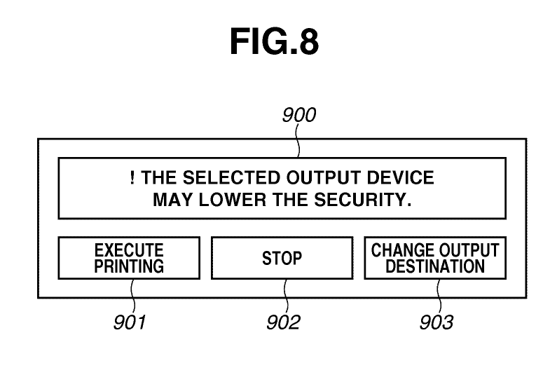

Consequently, in step S604, the CPU 101A determines that, since the security level of the transmission destination (output destination) is lower than the security level of the transmission source, the both security levels do not match to each other (NO in step S604), the processing proceeds to step S605. In step S605, the CPU 101A of the information processing apparatus 101 displays a dialog (UI) illustrated in FIG. 8, in which the next processing on the selected image data is inquired to the user, on the display device 200.

FIG. 8 illustrates an example of a user interface to be displayed on the display device 200 of the information processing apparatus 101 illustrated in FIG. 1. FIG. 8 is an example of the dialog for alarming the user that the security level of text information does not match the security level of the printer as the output destination selected by the user, and inquiring the user if the user changes the output destination or executes/stops printing.

In FIG. 8, a warning message 900 is displayed. Buttons 901 through 903 are used for selecting a candidate executable alternate processing. The button 901 functions as a print execution button, which is clicked when the image data is output. The button 902 functions as a print stop button, which is clicked when the image data is stopped to be output to the image processing apparatus 107. The button 903 functions as an output destination change button, which is clicked when the user selects the other image processing apparatus of which security level matches the security level of the information processing apparatus 101.

If the user operates through the interface the information processing apparatus 101 to output the image data to the selected output destination printer, the user can confirm the lowering of the security level (authentication level).

A display timing of the user interface is a time before the selected text information is output to the selected output destination printer. Therefore, it may be possible to prevent the output of the image data to the image processing apparatus with which the security level may be lowered.

Now, in step S606, the printer driver of the information processing apparatus 101 determines whether or not the user clicks the button 903 displayed on the user interface illustrated in FIG. 8. If the CPU 101A of the information processing apparatus 101 determines that the button 903 is clicked by the user (YES in step S606), the processing returns to the step S603.

With the processing described above, since an output printer list illustrated in FIG. 7 is displayed on the display device 200, the user performs the operation to select the image processing apparatus that is suitable for the security level of the image data from the output printer list. That is, the user can change the image processing apparatus as the output destination to the other image processing apparatus that can secure the security level.

In this case, when the CPU 101A determines that the image processing apparatus, of which security level is equivalent to the security level “2”, is selected again based on the security level management table 4000 in step S603 (YES in step S604), the processing proceeds from step S604 to step S609.

In step S609, the printer driver of the information processing apparatus 101 displays a setting screen of an output format (not illustrated) on the display device 200 to accept the print setting the user selected. In step S610, a print job including a designation of the output format according to the accepted print setting and the image data is output, thereby completing the present processing. The output format means here the number of printing or a reduced layout of the text information.

On the other hand, in step S606, when the CPU 101A of the information processing apparatus 101 determines that the button 903 is not clicked, the CPU 101A further determines whether or not the button 901 is clicked. This is because, even when the warning screen of FIG. 7 is displayed, the image can be output by the output destination printer selected in step S603 according to the selection by the user.

In the present exemplary embodiment, if the user selects the button 901 even when the warning indicative of the lowering of the security level is displayed, the image data can be output to the output destination printer having already been selected.

In step S606, when the printer driver of the information processing apparatus 101 determines that the button 901 is clicked (NO in step S606), the processing proceeds to step S607. In step S607, when the CPU 101A determines that the user selected the button 901 (YES in step S607), the processing proceeds to step S609.

On the other hands, in step S607, when the CPU 101A of the information processing apparatus 101 determines that the button 901 is not clicked by the user (NO in step S607), the proceeding proceeds to step S608. In this case, since the button 902 is clicked by the user in the user interface in FIG. 7, in step S608, the CPU 101A of the information processing apparatus 101 cancels printing of the text information and completes the processing.

Accordingly, the user recognizes the lowering of the security by the user interface in FIG. 7 and, when the user desires to output the data by the image processing apparatus 107, the user can output the data through the image processing apparatus 107. Further, if the user wants to cancel the output of the print data at this timing, the user can cancel the output of the print data and the processing according to the user's demand can be executed.

As described above, the output operation of the image data is completed and the image data is temporarily held in the image memory 3b of the image processing apparatus as a job.

Then, the user comes up to the image processing apparatus that the user designated in the list screen in FIG. 7 to perform the authentication by the user authentication unit of the image processing apparatus. If the image processing apparatus is the one that performs the user authentication only with the password, the image processing apparatus performs the user authentication only with the password.

On the other hand, if the image processing apparatus is the one that performs the user authentication by the fingerprint information in addition to the password, the image processing apparatus performs the user authentication by the fingerprint information in addition to the password. When the authentication is successful, the image processing apparatus assigns the right to use the image processing apparatus to the user.

When the user is assigned with the right to use the image processing apparatus, the user designates the image data stored in the image memory 3b, and issues a print instruction. When the image processing apparatus receives the print instruction of the image data from the user, the image processing apparatus prints the image data to which the print instruction is issued. Further, the user may issue a transmission instruction and a display instruction in addition to the print instruction.

In step S604, a case is described above where the CPU 101A of the information processing apparatus 101 determines that the security level responded from the printer server 102 matches the security level of the own apparatus, the processing proceeds to step S609. However, in a case where the security level responded from the printer server 102 is higher than the security level of the own apparatus, the processing may also proceeds to step S609. This is because the security level would not be lowered even if the data is stored in the output destination image processing apparatus from the information processing apparatus.

As described above, in the present exemplary embodiment, in a case where the security level of the image processing apparatus as the transmission destination is lower than the security level of the authentication unit of the information processing apparatus as the transmission source, the output of the image data is restricted. Accordingly, in a case where the image data stored in the information processing apparatus is output to the image processing apparatus, the lowering of the security level caused by the difference in the authentication level between the authentication units of the apparatuses can be restricted.

Now, a second exemplary embodiment of the present invention is described below. A configuration of the image processing system according to the present exemplary embodiment is identical to that of the first exemplary embodiment. The configurations of the image processing apparatus 107, 108, and 110 are identical to those of the first exemplary embodiment.

In the present exemplary embodiment, a case is described where the image data stored in the storage device 115 of the image processing apparatus 110 in FIG. 1 is transmitted to the image processing apparatus 108 that is connected to the network 112 in order to print the image data.

The image processing apparatus 108 is, as illustrated in the security level management table 4000 in FIG. 5, the one assigned with the security level of “1”, i.e., including the password authentication system. The image processing apparatus 107 and 108 on the network correspond to the other image processing apparatuses viewed from the image processing apparatus 110, and the image processing apparatus 110 corresponds to the other image processing apparatus when viewed from the image processing apparatus 107 and 108.

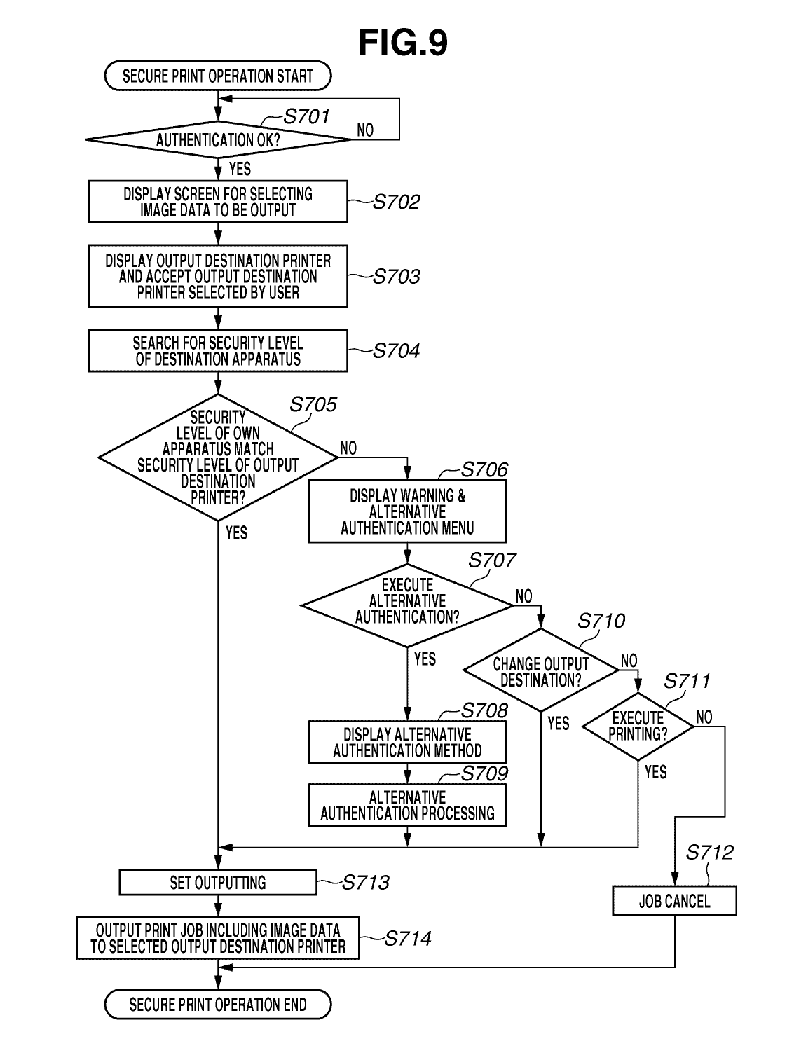

FIG. 9 is a flowchart illustrating an example of data processing steps of the image processing apparatus according to the present exemplary embodiment. Each step is realized by the CPU 2a of the image processing apparatus 110 loading and executing the control program onto/on the RAM 2c. The image processing apparatus 110 includes, as illustrated in FIG. 1, the ID authentication input apparatus 121.

The user operates the image processing apparatus 110 and inputs the ID number and the password, for example, through the operation unit 2d. Further, the user inputs the fingerprint information of the user by using the ID authentication input apparatus 121 connected to the image processing apparatus 110.

In step S701, the CPU 2a of the image processing apparatus 110 determines whether or not the input ID number, password, and fingerprint information match the information preliminary registered in the image processing apparatus 110, thereby determining whether or not the user authentication is successful. When the CPU 2a of the image processing apparatus 110 determines that the authentication is not successful (NO in step S701), the processing of S701 is repeated.

On the other hand, in step S701, when the CPU 101A of the information processing apparatus 101 determines that the authentication is successful (YES in step S701), the processing proceeds to step S702. Then, in step S702, the CPU 2a of the image processing apparatus 110 displays a screen (not illustrated) for selecting the image data to be output on the operation unit 2d.

In step S703, the CPU 2a of the image processing apparatus 110 displays a selection screen for selecting the image processing apparatus as the output destination printer on the operation unit 2d. The display screen form may be the same as that in FIG. 7 or may be another display form.

Further, the CPU 2a of the image processing apparatus 110 accepts the output destination printer the user selected in the screen displayed on the operation unit 2d. In the present exemplary embodiment, a description is continued provided that the image processing apparatus 108 is selected as the output destination printer that the user desires to print the data thereby. The image processing apparatus 108 is, as illustrated in FIG. 5, the one including only the password authentication system as the authentication system.

Now, the CPU 2a of the image processing apparatus 110 transmits an acquisition command for acquiring the security level with respect to the image processing apparatus 108 to the printer server 102. The printer server 102 relays the received acquisition command to transmit to the image processing apparatus 108 that is selected by the user as the output destination.

The image processing apparatus 108, which has received the acquisition command, executes an interpretation of the acquisition command by the CPU 2a through the communication unit 8, and acquires the authentication system information of the own apparatus, and the image processing apparatus 108 returns the result thereof to the image processing apparatus 110 as the acquisition result of the authentication system.

The image processing apparatus 108 includes a “password authentication system” in which information as to a password and an encoded private code as private information, that is key-input from the operation unit 2d, is authenticated, as described in the first exemplary embodiment. The image processing apparatus 108 replies information indicative of security level “1” corresponding to the “password authentication system”.

As described above, the command returned from the image processing apparatus 108 is received by the image processing apparatus 110 as the transmission source of the acquisition command through the printer server 102.

In step S704, the CPU 2a of the image processing apparatus 110 analyzes the received command. Accordingly, the CPU 2a determines that the security level of the password authentication system of the image processing apparatus 108 as the output destination is “1”. Then, in step S705, the CPU 2a of the image processing apparatus 110 determines whether or not the security level of the own apparatus matches the security level of the image processing apparatus 108 determined in step S704.

As described in the first exemplary embodiment, the image processing apparatus 110 includes a double security system, which can perform both of the password authentication and the fingerprint authentication. Therefore, the security level of the image processing apparatus 110 is “2”.

Therefore, the CPU 2a of the image processing apparatus 110 determines that, when comparing the two security levels, the security level of the image processing apparatus 108 as the output destination is lower than the security level of the image processing apparatus 110 as the transmission source (NO in step S705), the processing proceeds to step S706.

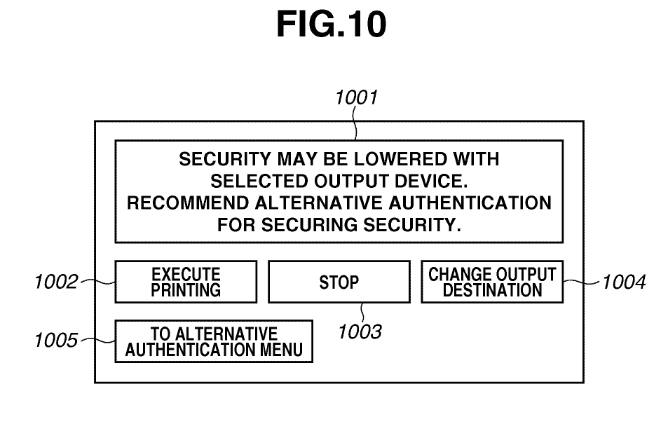

In step S706, the CPU 2a of the image processing apparatus 110 displays a user interface in FIG. 10 on the operation unit 2d in a similar manner as in the first exemplary embodiment. In the present exemplary embodiment, the CPU 2a of the image processing apparatus 110 displays, as illustrated in FIG. 10 described below, a warning screen indicative of lowering of the security level. The user can recognize that the security level is lowering when the user confirms the warning screen.

FIG. 10 illustrates an example of a user interface displayed on the operation unit 2d of the image processing apparatus 110 in FIG. 1.

Buttons 1002 through 1004 in FIG. 10 have the same configurations as the buttons 901 through 903 illustrated in FIG. 8, so that detailed descriptions thereof are omitted here. In FIG. 10, as a warning message 1001, a message to recommend the alternative authentication is displayed. The present exemplary embodiment includes, as the alternative authentication method, three alternative authentication methods corresponding to the following buttons, respectively. However, the alternative authentication method is not limited to the three methods.

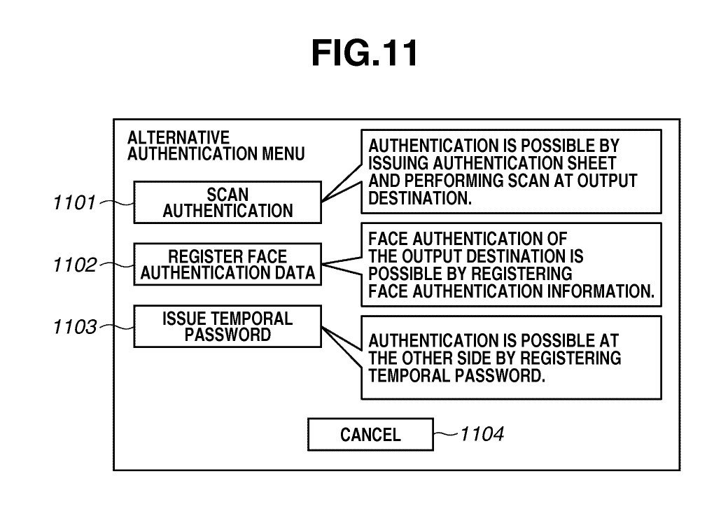

A button 1005 displays the alternative authentication menu. The button 1005 functions as a button for displaying a user interface described below referring to FIG. 11.

FIG. 11 illustrates an example of a user interface displayed on the operation unit 2d of the image processing apparatus 110 in FIG. 1. This corresponds to a menu for selecting an alternative authentication candidate. The alternative authentication candidate represents an authentication processing that is additionally required in addition to the authentication processing performed by the original authentication system that the image processing apparatus as the output destination requires in order to assign the user the right to use the image processing apparatus.

In FIG. 11, the button 1101 is clicked when a scan authentication is selected. The scan authentication button is a button for printing, in the image processing apparatus as the transmission source of the image data, an authentication sheet including information of a bar code in which the user's authentication information is embedded.

The user causes the printed authentication sheet to be scanned by the image processing apparatus as the output destination to thereby executing the authentication. The authentication information of the user used here may be preliminary registered in the image processing apparatus as the output destination, or may be registered in the print server 102. Thereby, the user authentication can be performed by checking the scanned authentication information with the registered authentication information.

The button 1102 is clicked when a face authentication data registration function is selected. Now, processing in a case where the authentication is performed based on the face authentication data registration function is described below.

The CPU 2a of the image processing apparatus 110 takes a photograph of a face of the user himself by using a camera function installed in a portable phone or the like that the user can use. Then, thus photographed face information is added to the image data to be output through a general-purpose interface of the image processing apparatus 110 as the transmission source. Subsequently, the CPU 2a of the image processing apparatus 110 transmits the image data to the image processing apparatus 108 as the output destination.

When the image data is printed by the image processing apparatus 108 as the output destination, the user transmits the face information in the portable phone to the image processing apparatus 108 and causes the image processing apparatus 108 to authenticate the user by using the face information. The image processing apparatus 108 performs a control so that the image data is printed in a case where the authentication is successful, whereas the image data is not printed in a case where the authentication was not successful.

The button 1103 is clicked in a case where a temporal password issuing function is selected. Now, a case where the authentication is performed based on a temporal password issuing function is described below.

When the button 1103 is clicked, the image processing apparatus 108 as the transmission source issues a temporal password (for example, password having a limit in the use number or a time limit), and causes the operation unit 2d to display the temporal password. The image processing apparatus 108 transmits the image data to be output to the image processing apparatus 110 together with the issued temporal password to the image processing apparatus 110.

The image processing apparatus 110 temporarily holds the received image data and a temporal password. The user issues the print instruction of the image data held by the image processing apparatus 110. When the user issues the print instruction of the image data and inputs the temporal password, the image processing apparatus 110 authenticates the user based on the temporal password. The image processing apparatus 110 controls so that the image data is printed when the authentication of the user is successful, whereas the image data is not printed when the authentication of the user is not successful.

Now, the description returns to the flow chart again. In step S706, after the screen in FIG. 10 is displayed, the processing proceeds to step S707. In step S707, the CPU 2a of the image processing apparatus 110 determines whether or not the button 1105 for selecting the alternative authentication menu in FIG. 10 is clicked. When the CPU 2a of the image processing apparatus 110 determines that the button 1105 for selecting the alternative authentication menu is clicked (YES in step S707), the processing proceeds to step S708.

In step S708, the CPU 2a of the image processing apparatus 110 causes the operation unit 2d to display the alternative authentication menu in FIG. 11. The alternative authentication menu displayed on the operation unit 2d may be displayed based on a function of the image processing apparatus 110 as the transmission destination and a function of the image processing apparatus 108 as the output destination. For example, in a case where the image processing apparatus without a scanner is selected, since the scan authentication cannot be carried out, the scan authentication key 1101 is made so as not to be selected.

Then, in step S709, the CPU 2a of the image processing apparatus 110 executes the alternative authentication processing according to each of the buttons 1101 through 1103, and the processing proceeds to step S713.

Each of steps S710 through 713 is identical to the corresponding one of steps S606 through S608 in FIG. 6. In the present exemplary embodiment, buttons 1002 through 1004 for changing the output destination described in the first exemplary embodiment are also displayed in addition to the alternative authentication menu button 1005 together with a display of a warning screen as illustrated in FIG. 10. Accordingly, the user can recognize the lowering of the security level, and can select the output operation of the image data that the user intended to.

In step S713, the CPU 2a of the image processing apparatus 110 causes the operation unit 2d to display a setting screen, and accept a print setting that the user selected. In step S714, a job including a designation of the output form according to the accepted print setting, and the image data is output to the image processing apparatus 108 to complete the present processing. The output form here represents the number of printing, a reduced layout, and the like of the image data.

With the above-described control, an output operation of the image data is completed, and thus output image data is temporarily stored in the image memory 3b of the selected image processing apparatus 108.

Then, the user comes to the image processing apparatus 108 to perform the authentication processing by using the authentication system of the image processing apparatus, in a manner similar to the first exemplary embodiment, and thereafter designates the image data and issues the print instruction thereof. In this case, when any one of the above-described alternative authentication candidates is selected, processing according to the alternative authentication candidate is performed in order to print the image data.

The image processing apparatus 108 perform control so that the image data is printed in a case where all the authentication necessary for printing the image data, that is temporarily held in the image processing apparatus 108, is successful, whereas the image data is not printed in a case where the authentication is not successful.

As described above, in the present exemplary embodiment, in a case where the security level of the image processing apparatus as the transmission destination is lower than the security level of the authentication unit of the information processing apparatus as the transmission source, the output of the image data is restricted. Accordingly, when the image data stored in the information processing apparatus is output to the image processing apparatus, the lowering of the security level caused by a difference of the authentication level between the authentication units of the apparatuses can be restrained.

In a case where the security level is lowered, authentication processing necessary for outputting the image data can be added in the image processing apparatus as the output destination.

In the above-described exemplary embodiment, an example that the security level management table 4000 is managed by the server computer 102 is described. However, the present invention is not limited thereto, but the information processing apparatus or the image processing apparatus included in the image processing system may manage the authentication system and authentication level included in corresponding apparatuses to each other.

The way to define the security level is not limited to the examples in the above-described exemplary embodiments. For example, the password authentication may be stolen at glance by other people, whereas the fingerprint authentication would not be stolen at glance. Therefore, the apparatus that performs the authentication only with the fingerprint authentication can be set to a higher security level than the apparatus that performs the authentication only with the password.

As described above, the security level may be defined according to a type of the respective information processing apparatuses included in the image processing system, or according to a type of the authentication system necessary for obtaining the right to use the image processing apparatus.

Alternatively, regardless of the type of the security level, the security level may be defined according to the number of the information processing apparatuses included in the image processing system or the number of the authentication system necessary for obtaining the right to use the image processing apparatus.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-094598 filed Apr. 9, 2009, which is hereby incorporated by reference herein in its entirety.

What is claimed is:

1. An information processing apparatus for outputting image data to an image processing apparatus, which permits a use of the image data provided that a user authentication unit authenticates the user, the information processing apparatus comprising:
a selecting unit configured to select an image processing apparatus as an output destination of the image data, among a plurality of image processing apparatuses;
a determining unit configured to determine whether an authentication level of the user authentication unit necessary for permitting a use of the image processing apparatus selected by the selecting unit is lower than an authentication level of an authentication unit necessary for permitting a use of the information processing apparatus; and
a control unit configured to restrict outputting of the image data to the image processing apparatus selected by the selection unit in a case where the determining unit determines that the authentication level is lower.

2. An information processing apparatus according to claim 1, wherein a notification unit configured to notify, in a case where the determining unit determines that the authentication level is lower, the user that the authentication level is lower.

3. An information processing apparatus according to claim 1, further comprising:
a changing unit configured to change the image processing apparatus as an output destination of the image data from the image processing apparatus selected by the selecting unit to the other image processing apparatus in a case where the determining unit determines that the authentication level is lower.

4. An information processing apparatus according to claim 1, further comprising:
an adding unit configured to add authentication processing necessary for permitting a use of the image data by the image processing apparatus selected by the selecting unit in a case where the determining unit determines that the authentication level is lower.

5. An information processing apparatus according to claim 1, wherein the determining unit performs the determination based on a type of the user authentication unit and a type of the authentication unit.

6. A control method for controlling an information processing apparatus for outputting image data to an image processing apparatus that permits a use of the image data provided that a user authentication unit authenticates a user, the method comprising:
selecting an image processing apparatus that serves as an output destination of the image data among a plurality of image processing apparatuses;
determining whether an authentication level of a user authentication unit necessary for permitting a use of the selected image processing apparatus is lower than an authentication level of the authentication unit necessary for permitting a use of the information processing apparatus; and
restricting an output of the image data to the selected image processing apparatus in a case where it is determined that the authentication level is lower.

7. A computer-readable storage medium for storing a computer program for controlling an information processing apparatus for outputting image data to an image processing apparatus that permits a use of the image data provided that a user authentication unit authenticates a user, the computer program comprising:
a code to select the image processing apparatus as an output destination of the image data among a plurality of image processing apparatuses;
a code to determine whether an authentication level of a user authentication unit necessary for permitting a use of the selected image processing apparatus is lower than an authentication level of an authentication unit necessary for permitting a use of the information processing apparatus; and
a code to restrict outputting of the image data to the selected image processing apparatus in a case where it is determined that the authentication level is lower.
